(19) United States
(12) Patent Application Publication
(10) Pub. No.: US 2004/0095623 A1
(43) Pub. Date: May 20, 2004

(54) System and method for assisting customers in selecting components for optical scanner systems

(76) Inventors: Charles Barresi, Grafton, MA (US); Jeffrey Zifcak, West Roxbury, MA (US); Kevin King, Dunstable, MA (US)

Correspondence Address: William E. Hilton, Samuels, Gauthier & Stevens, Suite 3300, 225 Franklin Street, Boston, MA, 02110, US

(21) Appl. No.: 10/300,516

(22) Filed: Nov. 20, 2002

(51) Int. Cl. G02B 26/08

(52) U.S. Cl. 359/198

(57) ABSTRACT

A system is disclosed for selecting and evaluating a plurality of optical scanning components assembled together in a virtual system. The system provides a selection screen displaying a plurality of optical scanning components which may be virtually assembled into a one, two or three-dimensional optical scanning system by computer modeling. The computer model provides a user interactive program to simulate the operation of the scanning system utilizing the components selected by the user. The simulation output includes frames for displaying data derived by the model and an animated representation of the operating scanning system including displaying a beam being scanned by the scanning system.

### BACKGROUND

The invention generally relates to a computer system for displaying, demonstrating and evaluating performance criteria of components used in optical scanning and the like. In particularly the invention relates to systems for assisting customers in selecting components for optical scanning applications.

Conventional optical scanners typically include a variety of components, e.g., galvanometer motors, sometimes called limited rotation DC torque motors, angular position detecting devices for providing active signals corresponding with an instantaneous angular position of the galvanometer motor and a motor driver for driving the motor rotation in accordance with a desired rotation profile. In typical high accuracy applications, the motor and motor driver may be a closed loop servo system for driving the motor angular position by nulling any difference between the desired motor angular position and the actual instantaneous motor angular position determined by the position sensor. In other less demanding applications an open loop motor driver combination may meet the demand of the application.

A scanning system also includes a scanning element, which may be a mirror, prisms, optical grating, or the like, for deflecting or redirecting an optical beam over a scan angle. The scan angle may be very small, e.g. a few degrees, or the scan angle may range over the entire angular range of motion of the limited rotation motor, up to about 45 degrees peak to peak. Of course other components may also be used in the scanning system such as a radiation source, a beam modulator, lenses, fold mirrors and other electro-mechanical or electro-optical devices for further conditioning, measuring or otherwise directing the scanning beam. In addition, the beam wavelength, diameter and power are all factors that must considered when selecting a scanning device for a particular application.

Scanning systems may be required to scan or direct an optical beam over a one two or three-dimensional space. Such optical scanners may be commercially available as assembled units, or may be purchased as individual components for assembly by a purchaser to meet specific operating criteria. One example of a two dimensional scanning systems is shown schematically in FIG. 11 by way of example. In the example a two dimensional scanning system 500 scans a radiation beam over a two-dimensional area 505, e.g. a flat surface. The scanning system, which is well known includes two scanning assemblies 510 and 515 scanning across an X axis of the area 505 and a Y axis of the area 505 respectively. Each scanning assembly 510 and 515 includes a galvanometer motor 520 and 525, a scanning mirror 530 and 535 and an angular position detector 540 and 545. A servo driver 550 includes separate servo controllers 555 and 560 for delivering a motor drive current to each motor 520, 525 and for receiving feedback signals from the angular position detectors 540, 545 respectively.

A laser beam generator 565 outputs a radiation beam 570 which may be conditioned according to the system requirement by a system shown at 575. A lens 580 may be provided to focus the laser beam to a small diameter on the surface 505 or the beam may not be focused on the surface 505. A system controller 585 is provided to control the position of the beam on the surface 505 and any modulation of the laser beam as required. The system controller 585 may be a self-contained system of may receive desired beam motion pattern signals from outside at port 590.

Such a scanning system may by used for a variety of applications ranging from scanning the surface 505 to collect information, scanning the surface 505 for recording information, such as text or an image onto the surface 505, processing the surface 505 with the laser beam, example for trimming or repairing electronic components, cutting, slicing, welding or drilling holes in the surface 505 or any number of other processes. Moreover, the laser beam may have any wavelength ranging from infrared to XRAY.

There are three modes of operation typically used in such a scanning system. The first mode, which is called raster scanning, is shown at line 600. In the raster mode the system scans the laser beam 570 over the surface 505 in a series of substantially parallel lines, or scan lines. In this mode, the X-axis scanner 510 operates at high frequency while the Y-axis scanner 525 operates at a lower frequency. For this application, the mirror 535 is more massive than the mirror 530. Accordingly, each component of the Y axis scanning system, namely motor 525, mirror 535, position detector 545 and servo driver 560 may have different performance and design characteristics with respect to the same elements of the X axis scanning system.

In a second mode of operation called a vector mode, the beam 570 may need to be continuously scanned over an irregular path such as is shown by the feature 605. In this case each of the X and Y scan systems must be simultaneously moved according to a vector defined path to form a continuous or semi-continuous line on the surface 505. Such a mode may be used in laser marking or engraving or in a laser light shown application.

In a third mode of operation called a step mode, the system may be required to direct the beam 570 to discrete locations on the surface 505 as might be indicated by the points 610. One example of such an application is laser drilling which may require the holes be drilled at exact locations on the surface 505.

In each new scanning application, a variety of system parameters need to be specified in order to determine if a particular combination of elements can be assembled that will meet the system parameters. For example, system parameters may be defined by criteria such as the dimensions of the scan area 505, the required beam position accuracy, the beam spot size at the surface 505, the speed of movement of the beam, the settle time of the beam upon stopping, the wavelength and power of the beam the desired system cost and others. The system requirements then must be transferred back to the requirements of the individual components to see if there are one or more combinations of components that could meet the system needs.

In the past, the determination of whether a particular combination of components meets certain operating criteria has generally required that the components be physically assembled and tested in a lab environment.

Although the performance characteristics of each galvanometer motor and mirror may be known, it is not always apparent how the components will interact in an optical scanner assembly in which they are combined. The determination of the performance criteria of an optical assembly of the combined components, therefore, may, require that the specific components selected be purchased, assembled into an optical assembly, and tested in a lab environment. Such testing not only requires that numerous components may have to be purchased, but also requires substantial time and resources to conduct the testing.

There is a need, therefore, for a system and method that facilitates the selection of components for the design and testing of optical scanning systems. There is a further need for a system and method for quickly evaluating proposed scanning system designs and moreover for modeling a system's performance. There is a further need to quickly evaluate multiple component combinations to determine which combinations can best meet the system needs.

### SUMMARY OF THE INVENTION

The invention provides a system and method for selecting a plurality of optical components for evaluating a scanning system built from the components. In particular the system provides a selection screen displaying a plurality of components, systems and scanning applications all relating to forming a one, two or three-dimensional optical scanning system. One or more of the displayed optical components may be selected by a user to evaluate.

Upon selection, data relating to each of the selected optical components is retrieved from a database and may be displayed in regions of the display screen for review by the user. The displayed data may include images graphics audio and video data. Upon further selection by an operator, a virtual lab model of the system is generated by the system, which includes a controller having an interacting program operating thereon. The controller may be accessible by users remote from the controller. According to the model, the controller and interactive program simulate the operation of the scanning system utilizing the selected components and the data related thereto.

The view the simulation and resulting data generated by the model, an evaluation screen may be displayed to evaluate the performance of the components assembled into the scanning system. The evaluation screen may include frames for displaying data derived by the model for evaluation by a user and the displayed data may include an animated representation of the operating scanning system including displaying a beam being scanned by the scanning system.

In addition, the evaluation mode may include selecting one or more operating modes for the various scanning elements. Upon the selection of an operating mode, the model will be run using the selected operating mode. In a particularly useful example of the invention, the user may select two galvanometer scanning motors, two galvanometer scanning mirrors and two servo current drivers for driving the galvanometer motor movements. The operator may then select an operating mode for each of the galvanometers, e.g. step mode, raster mode and vector mode and the selected system will be modeled by the system. The operator may then observe the system operation, evaluate the system performance and generally make a decision about whether the selected components may have the characteristics desired for a scanning system to be designed.

### BREIF DESCRIPTION OF THE DRAWINGS

The following description may be further understood with reference to the accompanying drawings in which:

FIG. 1 shows a two-dimensional scanning system of the prior art.

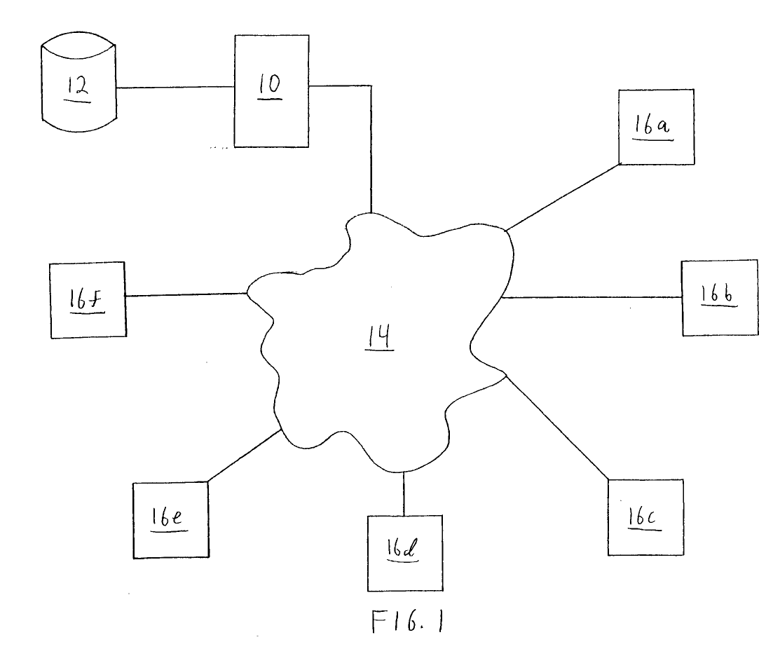

FIG. 2 shows a diagrammatic illustrative view of a system in accordance with an embodiment of the invention;

FIGS. 3 and 4 show diagrammatic illustrative views of a selection user interface system in accordance with an embodiment of the invention;

FIG. 5 shows a diagrammatic illustrative view of a virtual lab user interface system during step mode in accordance with an embodiment of the invention;

FIG. 6 shows an illustrative graphical representation of step mode data that is provided in a system in accordance with an embodiment of the invention;

FIG. 7 shows an illustrative table including step mode data that is provided in a system in accordance with an embodiment of the invention;

FIG. 8 shows a diagrammatic illustrative view of a virtual lab user interface system during raster mode in accordance with an embodiment of the invention;

FIG. 9 show illustrative graphical representation of raster mode data that is provided in a system in accordance with an embodiment of the invention;

FIG. 10 shows a diagrammatic illustrative view of a virtual lab user interface system during vector mode in accordance with an embodiment of the invention; and

FIG. 11 shows an illustrative flowchart of the processing steps in accordance with an embodiment of a system of the invention.

The drawings are shown for illustrative purposes and are not to scale.

### DETAILED DESCRIPTION OF THE ILLUSTRATED EMBODIMENTS

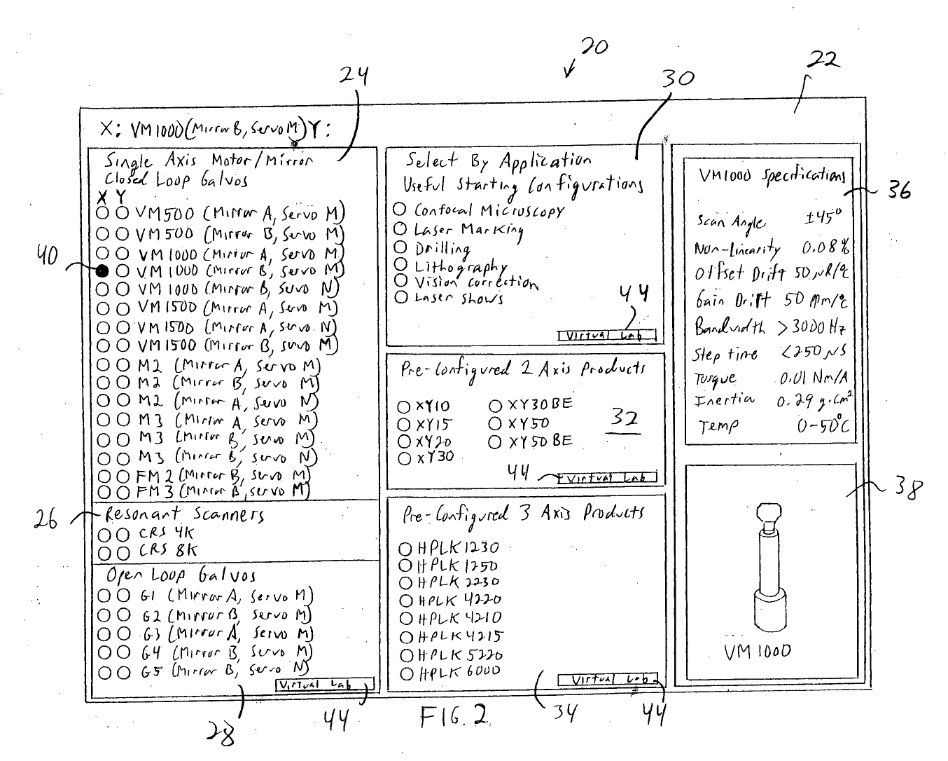

As shown in FIG. 2, a customer accessible system in accordance with an embodiment of the invention includes a central controller 10 that is coupled to a central database 12 and a network 14, which in turn is coupled to remote stations 16a-16f. A customer may access the central controller 10 from any of the remote stations 16a-16f that communicate with the central controller 10 via the network 14 such as the Internet or an Intranet installation. An interactive computer program according to the invention is stored and operated at the central controller 10. The controller 10 may comprise any computer system having a central processor, electronic memory, user interface and communication ports. The database 12 may be stored on a memory included with the controller 10 or may be stored separately and accessed by the controller 10. Through the interactive computer program, a customer may select, evaluate and test a wide variety of combinations of available components for assembly into optical scanners as discussed in more detail below.

In order to access the controller 10, a customer may connect from a remote location and access the interactive computer program stored and operating on the controller 10, remotely. The interactive computer program will operate interactively with any of the remote stations 16a-16f. Each remote station 16a-16f may comprise any computer system connected to a network. Access to the interactive computer program may be provided to a customer via the use of a customer account identification and password or the system may be made publicly available to anyone. In another embodiment, the interactive computer program may be made accessible only upon paying a fee. In further embodiments, the interactive computer program and database may be made available to customers via one or more compact discs or other information storage or memory device that are physically distributed to customers for use of their own computer systems or workstations without accessing the central controller 10 via a network. According to this embodiment, the interactive computer program and database will operate on the customers' computer without the need for communicating with the controller 10. In this case the customer computer system operates as the controller 10.

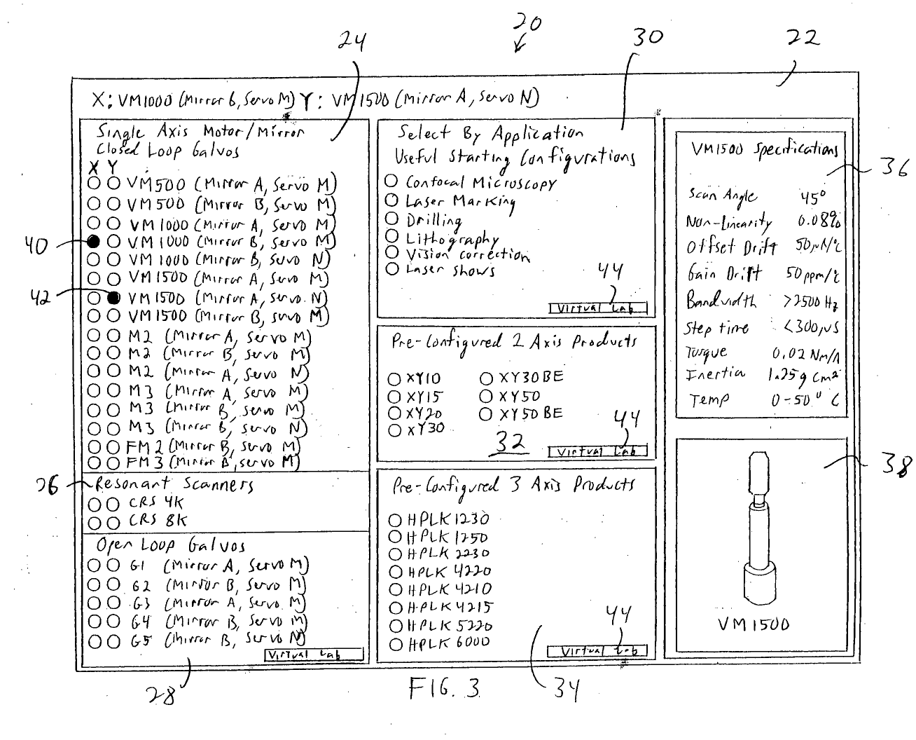

As shown in FIG. 3 and, a user interface screen of the invention includes a selection screen 20 displayed on any display screen at the controller 10 or at any of the remote station 16a-16f. The screen displayed user interface permits customers to select from a variety of optical scanning components and or optical scanning systems and to display information about the selected component and or system for evaluation The selection screen 20 includes a title bar 22, and various other frames, windows or display areas for displaying information. Accordingly, the controller 10 and each remote station 16a-16f include a display device driver for displaying text and graphics as required for conveying information to the user and the interactive computer program communicates display commands to the display device. The display commands will include commands for displaying text graphics, pictures, and real time video images. In addition, the controller 10 and each remote station 16a-16f may include an audio speaker and a driver for playing audio information to the customer according to audio commands generated by the interactive program.

As shown in FIG. 3, a plurality of closed loop galvanometer motor and mirror combinations are listed in frame 24. Frame 26 displays various resonant scanners and frame 28 displays open loop scanner selections. In frame 30, a plurality of scanning applications is listed and each of these may represent a pre-configured two-axis (x-y) scan head or scanning system typically used in the applications listed. In frames 32 and 34 numerous two and three axis pre-configured x-y and x-y-z scanning heads are displayed and are selectable by a user.

The selection screen 20 also includes a product specification section 36 and a product image display section 38. In accordance with the invention, a user may select any component or system from one of the frames 24, 26, 28, 30, 32 and 34 by a selecting action, e.g. by placing a mouse controlled cursor over one of the selection buttons associated with a selectable element. In the present example, a clear selectable button is displayed beside each selectable element or feature. Upon selection of a selection button, the clear circle is darkened to indicate to the operator that a selection has been made. Once the selection is made the controller 10 retrieves data relating to the selected element and displays that data the selection screen 20. The retrieved data may include a graphical or video representation of the component or system for display in frame 38, a set of component specifications for display in frame 36 and other data such an audio file, price information, availability, delivery time and any other information that may be helpful to a customer using the system.

Each of the components listed in frames 26, 28 and 40 includes a galvanometer motor and a mirror. Accordingly, selection of a button in frames 26, 28 and 40 results in selecting a matched scanning motor and mirror combination. Selection of a button in frames 28 and 40 results in selecting a matched scanning motor and mirror and a servo controller also matched with the motor mirror combination. In each of the frames 26, 28 and 40, the user must indicate whether the selected component will be used as an X-axis scanner or a Y-axis scanner. For example, the first item in frame 40 shows VM500 (Mirror A, Servo M). The item identifies a VM 500 galvanometer motor by model number, a mirror of type A and a servo current driver of type M. In this case, the selection of the item as an X-axis galvanometer or a -Y-axis galvanometer may define the shape and or size of the matched mirror, (e.g. Y mirrors are generally longer than X mirrors).

The mirror type may also designate the mirror performance characteristics, e.g. type A mirrors may be high performance mirrors having a very high stiffness, a very low mass, a difficult to achieve surface flatness or surface finish or a special mirror coating. Alternately type B mirrors may include lower performance and lower cost options and of course other types may be available and listed in the frames for selection. Similarly, type M servos may be high performance servos, e.g. high bandwidth, low noise, or the like, as compared to another type of servos (e.g., type N servos), which may be more stable or lower cost or have any other performance difference.

For example, as shown at button 40 in FIGS. 3 and 4 a customer has selected a VM 1000 unit as an X scanner having a mirror of type B and a servo of type M. The specifications for the selected scanner appear in the specification frame 36. The image frame 38 displays an image of the VM1000 with an X-type B mirror, as shown. The selected X scanner name is displayed in the title bar 22 identifying the selected X scanner components. In this manner, the user may make a selection, review the graphic representation of the component in frame 38, review the listed operating specification in frame 36, and make a first level design decision about whether the selected component has the necessary characteristics of e.g. the X-axis scanner of the system to be designed. After selecting an X-scanner, the user may then select a Y-scanner. As shown at button 42 in FIG. 4, a customer may then select the Y scanner in a similar fashion by selecting the appropriate button from the Y column that corresponds to the desired item. In this instance, the customer has selected a VM 1500 unit as a Y scanner having a mirror of type A and a servo of type N. The selected Y scanner is displayed in the title bar 22 with the previously selected X scanner as shown.

In another example, the customer may select a resonant scanner from frame 26 as the X scanner and/or the Y scanner, and the customer may further select from a variety of open or closed loop galvanometer motors, mirrors and servo combinations from frames 24 or 28. The X scanner need not be from the same category (close loop, open loop or resonant scanner) as the Y scanner. In general, neither the open loop galvanometers nor the resonant scanners include an angular position detector for providing angular position feedback in the control mechanism and therefore may have a different current driver than a servo driven current driver.

In further examples, the customer may alternatively select a-system or component application as may be listed in frame 30. The application e.g., confocal microscopy, laser marking, laser drilling, stereo lithography, vision correction and laser shows, appear listed in frame 30 and may be selected by selecting the button adjacent to each application using the cursor. By selecting a particular application, data relating to various pre-defined scanning systems typically used for the application may be downloaded from the database records and displayed in frames 36 and 38. According to the invention, examples of predefined scanning systems having performance characteristics or system configurations typical of the selected application may be displayed in the frame 38 with system specifications displayed in frame 36. For example, if a drilling system is selected, the computer program of the invention may show a pre-configured X-Y scanner having two closed loop galvanometer motors with appropriate mirrors and servo's matched for a drilling application. Alternately, the computer program could eliminate components not suitable for drilling from the displayed listed components and ask a user to make further choices from the remaining components. Such a step guides the user to only consider systems and or components most suitable for the selected application thereby simplifying the designers selection process.

If a predefined system is selected, the components may be listed individually in the title bar 22 or a system name or other identifying information may be listed. These items may appear listed in the title bar 22. In still further examples, the user may select from any of a plurality of pre-configured 2 and 3 axis scanning systems or products as listed in frames 32 and 34 respectively. These pre-configured products may include assembled scanner products having housings for supporting the galvanometers, lens and may also include a scanning beam source. Moreover, the systems may be pre-aligned and tested for certain applications. Pre-configured 3 axis products generally utilize the third motion axis for dynamically focusing a beam onto a contoured surface being scanned by a conventional x-y scanner.

The output sections 36 and 38 show the specifications and an image of an item that is associated with a darken button (40, 42) presently underneath the cursor on the selection screen 20. When the cursor is over any of the close loop, open loop or resonant scanner items in sections 24, 26 and 28, then the specification section and image section display the appropriate data and image for the darkened button. The system may further display the X or Y mirror in the image responsive to the position of the cursor (e.g., whether it is over the X or Y column). In certain embodiments, the combined X-Y scanning system performance characteristics may be limited by the performance of the largest mirror, which is usually the Y mirror. Accordingly, when displaying an X-Y scanning system, only the Y selection data of the combination may need to be displayed in specification frame 36 because it will dominate the system performance.

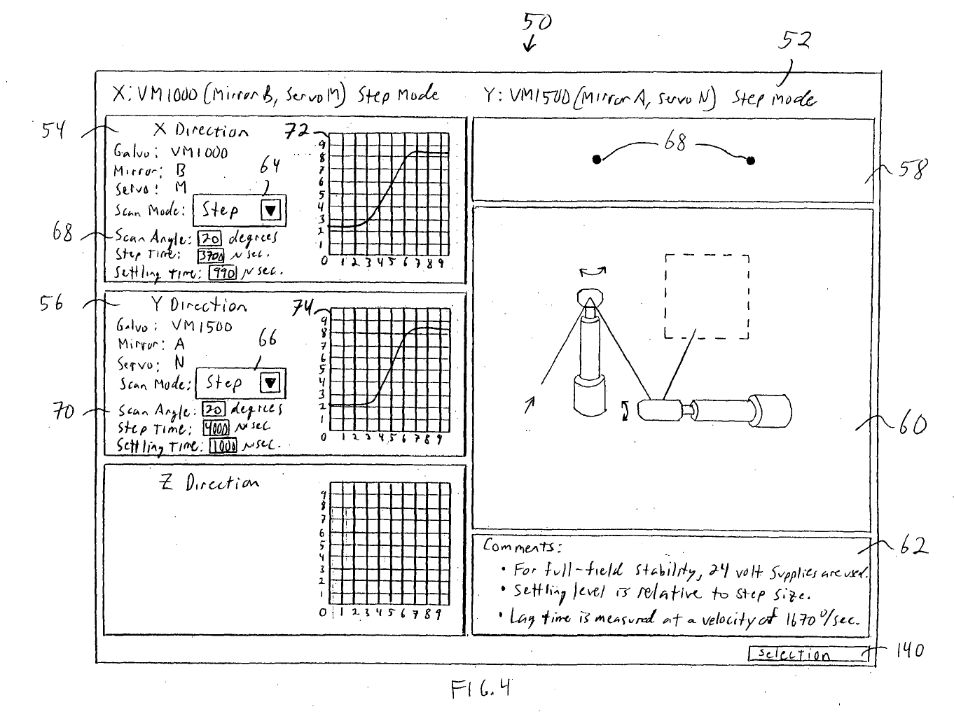

In the lower right hand corner of selected frames is a link button 44 labeled virtual lab. Selection of the virtual lab button 44 initiates a virtual lab screen. As shown in FIG. 5, the virtual lab screen 50 in accordance with an embodiment of the invention also includes a title bar 52, as well as an X-direction output data area 54, and a Y-direction output data area 56. In frame 60, a visual representation of the system selected by the user in the earlier steps is displayed for viewing. The extent possible, given the information available, the visual representation will display the scanning components in an orientation and position consistent with a final system design. Moreover, if some elements of the system are hidden in the visual image, the image may be cut away to show details hidden by elements in the forefront of the image. The interactive computer program may control the cut away feature or it may be user selectable. In accordance with the invention, three-dimensional visual models, such as may be generated by a computer added design, (CAD) drawing system are stored in the database along with other component data. In addition, the database may further store position and orientation data for placing each component in the visual image so that the computer program can display the selected elements in configuration consistent with normal operation.

A further aspect of the visual image displayed in frame 60 is that it also includes animation features. The animation features display the actual movement of the scanning mirrors in a manner consistent with the components and operating modes selected. According to this aspect of the invention, the interactive computer system uses information input by the user, e.g. scan angle range, scan frequency, scan efficiency and other inputs to dynamically model the movements of the selected system. Moreover, when the system operating frequency or step movement are too fast for tracking by the human eye, the computer program will slow down the motions of the animation to display the system motions at a speed that is easily visualized and evaluated.

In addition to dynamically modeling the movements of the selected system elements, the interactive computer program further dynamically models the beam deflected by the simulated scanning system and provides a visual representation of beam motion in frame 58. According to this aspect of the invention, a beam being scanned or otherwise directed by the scanning system is shown in frame 58 and is moved synchronously with the animated motion of the scanning components displayed in frame 60. To display a representation of beam motion in the frame 58, the database may include look-up tables for each scanning component. A look-up table may include pre-determined operating data relating, e.g. to the particular X or Y scanning components being modeled or relating to the specific combination of X and Y and possibly Z scanning elements being modeled. In one simple example, a look-up table for an X-scanning component may include a plurality of mirror angle positions and with each mirror angle position a corresponding X-position of a beam in an X-Y area being scanned. Similarly, a look-up table for a Y-scanning component may include a plurality of mirror angle positions and with each mirror angle position a corresponding Y-position of a beam in an X-Y area being scanned and similarly for a Z-position of a Z-axis scanner. Thus using look-up tables to display a beam in frame 58 the interactive computer program may start the X and Y scanning element in a start position, e.g. at one end of a scan range defined by a user, look-up the corresponding X and Y positions of the beam in the X-Y area being scanned and display a representative beam at the X-Y position in the display area 58. This process is repeated for each scan angle until an entire scan is modeled and displayed over the full range of scan angles. The animation is provided by continuously refreshing images displayed in frames 58 and 60 to provide a moving image that simulates actual operation of the selected components in an optical scanner. In addition to the look-up table the computer program may include algorithms for interpolating values not included in the look-up tables. Accordingly, in addition to the animated display feature of moving elements displayed in frame 60, the invention includes a corresponding animated representation of a beam scanning or being positioned or stepped through a scan field.

In another mode of operation, the interactive computer program may calculate the path or position of a scanning beam in real time. In this mode, instead of using a look-up table with predefined values, the system may use an algorithm to calculate a beam position vs scan angle and use the calculated results to control the simulated location of the beam being displayed in frame 58. Such a model may be well suited for a resonant scanner which merely oscillates through a scan range at a fixed frequency.

In addition to frames 58 and 60, frame 62 may further display other information relating to the selected combination of elements. Such information may include among other things, electrical characteristics of the elements selected, mechanical mounting information, thermal drift and or stability data, operating limitations, motion non-linearity features and any other information that may help a user make a design decision.

In order to develop a system model, a user enters information about the system design. In FIG. 5, the user selects a mode of operation of the scanner in each direction from a list of three possible operating modes, step mode, raster mode, and vector mode. If the customer selects step mode for the X direction as shown at 64 and step mode for the Y-direction as shown at 66, then the system will operate in step mode in both axes. Such a system may be used in laser drilling which requires rapid stepping between points in a scan area. As shown in frame 58, the simulated beam representation shows two points, 68a and 68b. In step mode a galvanometer motor is merely moved from a first fixed angular position to a second fixed angular position. In step mode, the user may enter the scan angle associated with the step to be taken to determine the scan time and the settle time of the system based on the scan angle. Key performance characteristics in step mode include the step duration and the settle time of the mirrors and motors. These parameters may be displayed in frame 54, which in FIG. 5 shows the step time and settle time for the particular step displayed in nanoseconds. The system may also provide a diagrammatic graphical illustration of a simulated oscilloscope signal for each of the x and y directions are shown at 72 and 74 respectively. As shown in frames 54 and 56, in display areas 72 and 74 a simulated trace of the motion of each of the X and Y components shows a plot of scan angle of the mirror along the vertical axis vs time along the horizontal axis. A system designer can use the plots to determine over which scan angles the motion is linear with respect to time.

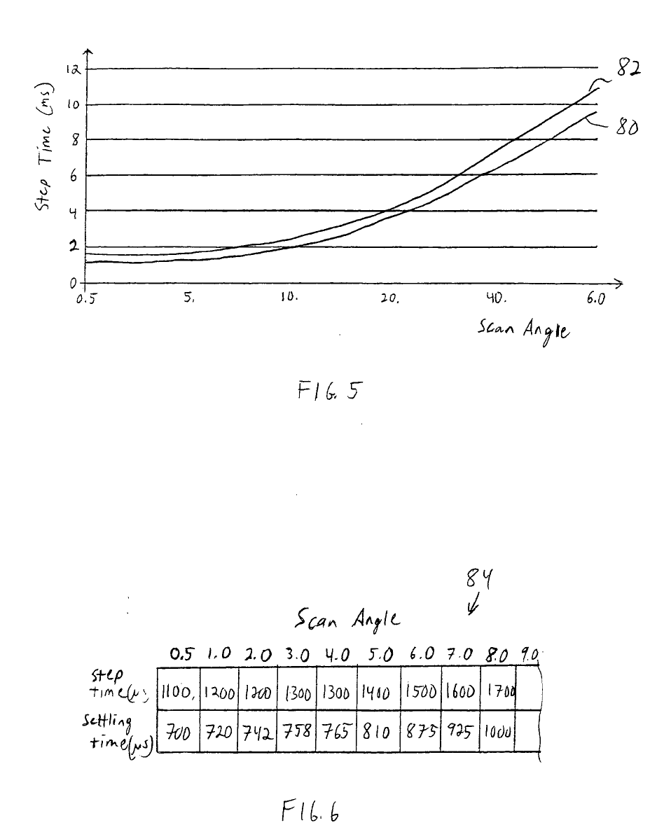

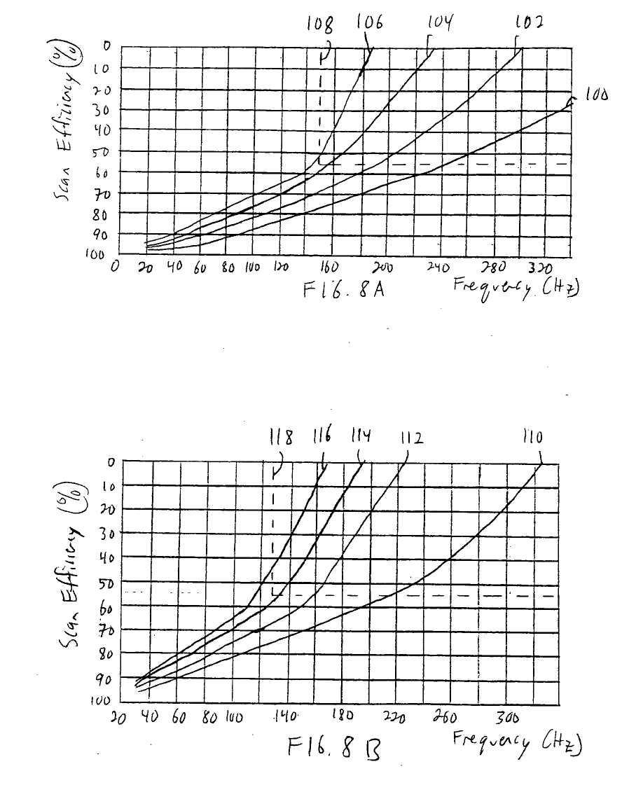

FIG. 6 shows a look-up table 84 displaying the data employed to generate the graphical operations discussed above for a single axis scanner operating in the step mode. The same data is shown graphically in FIG. 6 in which case the X direction scanner performance is shown at curve 80 and the data for the Y direction scanner is shown at curve 82. In the particular example illustrated in FIG. 6, for any given scan angle the curve 82 has a slower step time such that the system is step time limited by the Y scanner. In another example, shown in FIG. 8, a user selects raster mode for the X-scanner and a step mode for a Y-scanner in the virtual lab interface screen 50 as shown at 90 and 92. Such a configuration is typical for scanning recording an image onto or reading an image from a scan area surface. In raster mode, the X-scanner scans at a constant velocity from a first start position along the X-direction to a first end position, and then returns as quickly as possible to a new start position. During the return motion, the Y-scanner makes one step thereby directing the scan beam to a new Y position. The X-scanner then scan a substially parallel scan line in the new Y position. The scan designer may use the step angle of the step scanner to select the separation of adjacent scan lines in the Y-axis. A diagrammatic moving image of the output of such a scanner is shown at 94 in area 58 of FIG. 8, and a moving diagrammatic image of the operation of the selected components is shown in area 60. For a raster scanner the user selects two of scan angle, scan efficiency, and scan frequency. In the case of the raster scanner described above, a scan angle selection will determine the width of the scan along the X-axis. The scan efficiency is defined as the percentage of the scan angle that provides a linear scan angle vs time signature. This is shown as the linear portion of the curve shown in display area 72. In the case of the scan frequency, this defines the oscillation frequency of the mirror during scanning. In rater mode, given two of the three parameters, computer program calculates or otherwise provides the third parameter based on the values of the other two. For example, if the customer entered a scan angle of 10 degrees and a scan frequency of 140 Hz for the x direction, then the system would automatically show a scan efficiency of 80 as shown at 96 in area 54 of FIG. 8. If the customer entered a scan angle of 20 degrees and a scan efficiency of 70% for the X direction, then the system would automatically show a scan frequency of 120 Hz as shown at 98 in area 54 of FIG. 8. As described above, the step scanner make be selected by choosing a scan angle or a step time in frame 56.

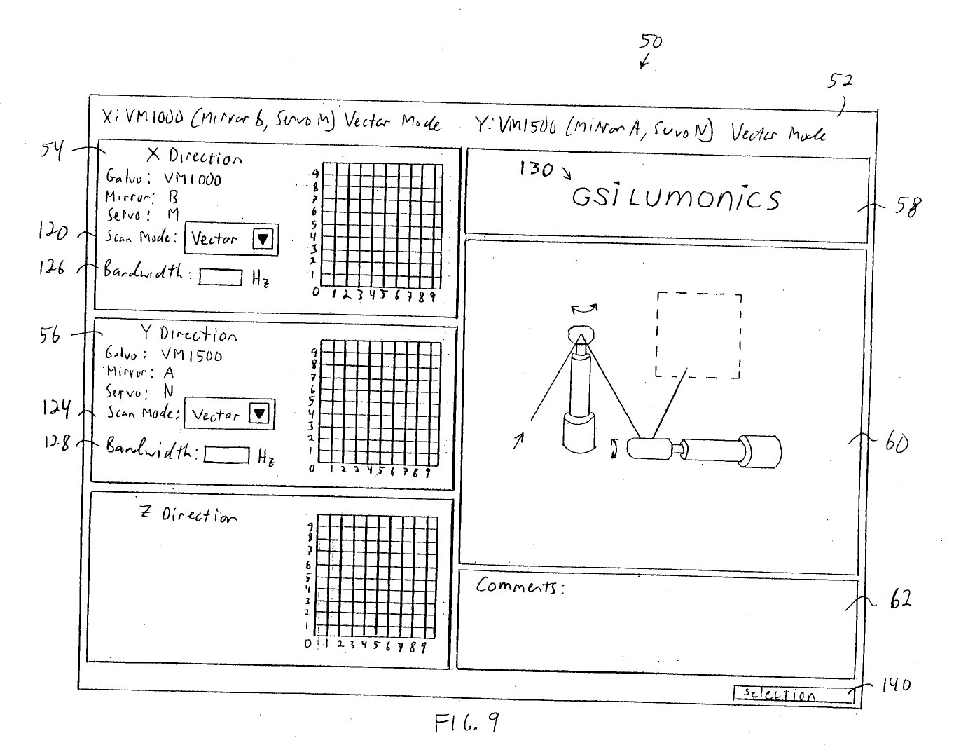

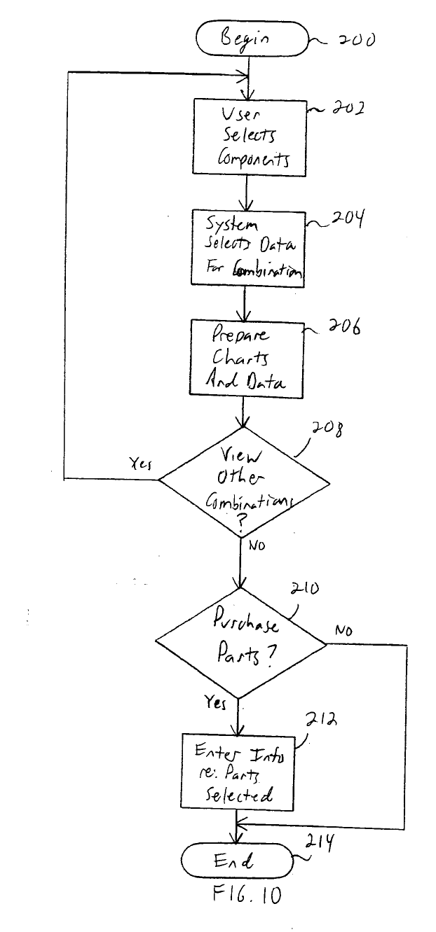

As shown in FIG. 9, typical data for a raster scanner stored in the database 12 may include relational scan frequency and scan efficiency data for several different angles (10 degrees, 20 degrees, 30 degrees, and 40 degrees as shown respectively at 100, 102, 104 and 106. If the selection made by a customer is in the upper area of the graph that is bordered by the dashed line 108, then the customer may be warned (e.g., in the comments section 62) that significant cooling may be required for the selected scanner using the selected operating criteria. In this case the operator has selected a high frequency and a low scan efficiency. In another example, a user may elect to view performance data for the selected combination when scanning in vector mode as shown at 120 and 124 in FIG. 10. Vector mode involves continuously positioning and scanning the output beam in each axis in accordance with an input signal, for example, for drawing characters or shapes in a laser marking application or for drawing or forming shapes in laser light shows. An important performance characteristic for such a system is the speed at which the system may follow the input signal or position commands. This speed is referred to as the component bandwidth, which is the frequency at which the gain of the system becomes −3 db. It is a maximum frequency at which the component can reliably operate without errors. In this case, a bandwidth reflects the performance of the combined galvanometer motor, scan mirror and servo driver. Similarly, the gain, which is the servo driver gain, is defined as the position output magnitude divided by the command input magnitude. The computer program will display the bandwidth for the selected X and Y scanning components at display areas 126 and 128 respectively. The beam display output frame 58 may show characters being drawn as indicated at 130, and frame 60 may show the selected optical components as they move during vector scanning.

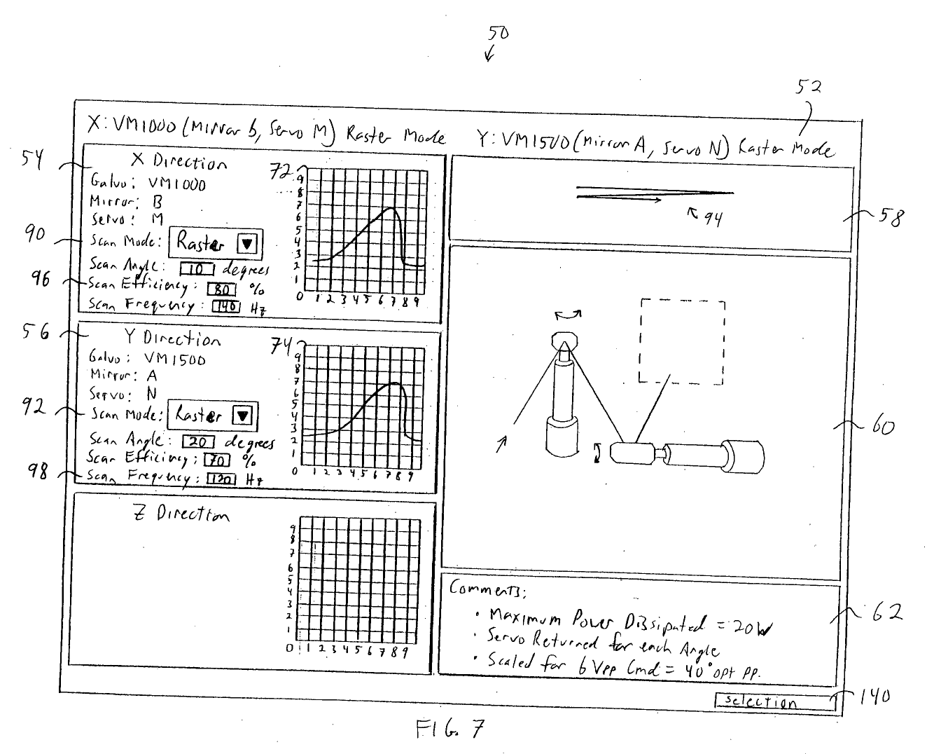

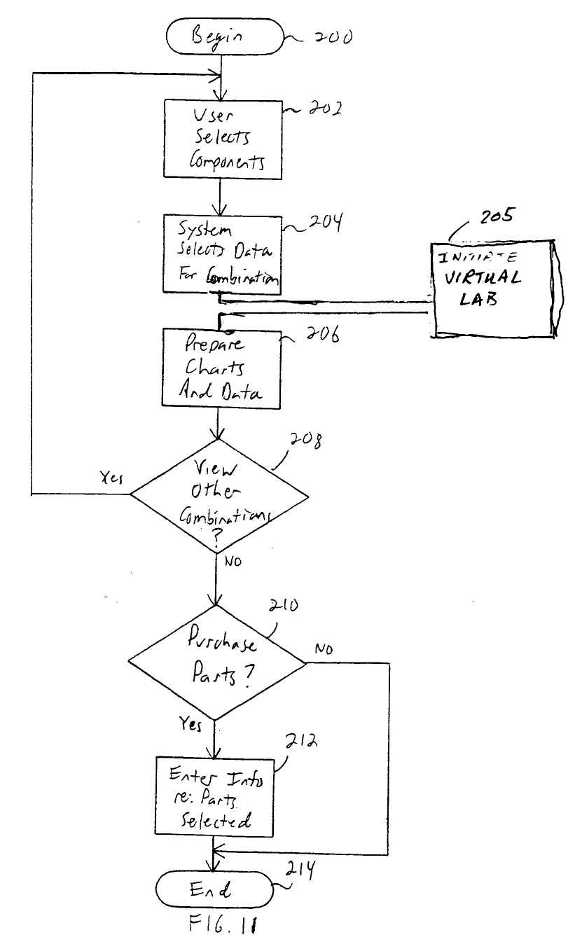

As shown in FIG. 11, a system of the invention may begin (step 200) by permitting a customer to select the components (step 202), which may include particular mirrors, galvanometer motors, servo controllers, or which may include resonant scanner that include combined galvanometer motors and mirrors, or may include a particular pre-configured x-y or x-y-z combination either by selecting the particular combination or by electing a particular application, in which case the system chooses a particular combination of components. The system then retrieves the appropriate data (step 204) from the database 12 for displaying an image of the selected component and any operating specifications in the display area 20 shown in FIGS. 3 and 4. Once the components have been selected an operator may select the virtual lab mode 205 which initiates the system modeling aspect of the process and displays a new virtual lab screen. In the virtual lab mode, the interactive computer program may call up look-up tables and or algorithms from the database 12 for modeling the selected components, and then prepare the output data and charts shown, for example, in FIGS. 4, 7 and 9 (step 206). After reviewing the initial system performance data, the user may then choose to step back to step 202 to select other components to model if desired (step 208). In this case, the user may return to the selection screen 20 at any time while viewing the virtual lab screen 50 by selecting the selection button 140 as shown in FIGS. 4, 7 and 9. If so, the system returns to step 202. In further steps, the customer may choose to purchase the components get a quote on the components or take some other action such as to save the selected combination for a future evaluation, (step 210). Otherwise, the interactive computer program ends the process (step 214) and may disconnect the user from the network after a time out. Of course other models and evaluation may be performed based on selecting predefined X-Y or X-Y-Z scanning systems, and these systems will be displayed in the animated fashion described above and with a scanning beam path being displayed in the beam display area 58. As also indicated, a user may return to the component selection areas and select one or more new components to evaluate. The interactive computer program will then update the specifications and images based on the new selections and the user may then return to the virtual lab screens to evaluate the new selections.

Those skilled in the art will appreciate that numerous modifications and variations may be made to the above disclosed embodiments without departing from the spirit and scope of the invention.

We/I claim:

1. A system for facilitating the selection of components for optical scanning, said system comprising:
a controller for operating an interactive program and including a video display generating means, a processing means and communication means;
a database stored on a memory accessible by the controller the database including data relating to the components for optical scanning;
a selection screen generated by the interactive program and displayed on a video display device in communication with the controller for permitting a user to select at least one optical component from a plurality of optical component choices displayed on the selection screen and to display at least a portion of the data relating to the selected component on the selection screen in response to the user selection; and,
an evaluation screen generated by the interactive program and displayed on the displayed device in response to a selection by the user, said evaluation screen including frames for demonstrating operation of the component in a scanning application.

2. The system as claimed in claim 1, wherein said optical component comprises a limited rotation scanning motor and a scanning mirror being rotated by the motor.

3. The system as claimed in claim 2, wherein said frames for demonstrating operation of the component in a scanning application display an animated image of the component in operation.

4. The system as claimed in claim 3 wherein said frames for demonstrating operation of the component in a scanning application further displays an animated beam being scanned by the component across a scan area.

5. The system as claimed in claim 1, wherein said selection screen includes frames for permitting the user to select at least one pre-configured optical system comprising more than one optical scanning element and further wherein the evaluation screen includes frames for demonstrating operation of the pre-configured optical system in a scanning application.

6. The system as claimed in claim 1, wherein said selection screen includes frames for permitting the user to select a plurality of optical scanning components and further wherein the interactive program includes program steps for configuring the selected optical scanning components into a scanning system.

7. The system as claimed in claim 6 wherein the interactive program includes further steps for displaying an animated image of the configured scanning system said animated image including a simulation of a beam being scanned by the configured scanning system.

8. The system as claimed in claim 1 wherein the evaluation screen further includes displayed elements for the user to select an operating mode of the selected component.

9. The system as claimed in claim 1 wherein the evaluation screen further includes displayed elements for displaying one of text and graphical information relating to performance of the selected optical component.

10. The system as claimed in claim 7 wherein the evaluation screen further includes displayed elements for displaying one of text and graphical information relating to performance of each of the selected optical components.

11. A method for evaluating optical components in a scanning system, said method comprising:
operating an interactive program on a controller;
permitting a user to select at least one optical component from a plurality of optical component choices displayed on a selection screen generated by the interactive program;
displaying data relating to the selected at least one component on the selection screen, said data being retrieved from a database by the controller; and,
displaying an evaluation screen in response to a user input, said evaluation screen including frames for demonstrating operation of the component in a scanning application.

12. A method for according to claim 11 further comprising the steps of:
selecting two galvanometer motors for modeling a two-axis optical scanning system;
selecting a scanning mirror for each galvanometer motor for modeling the two-axis optical scanner with the selected mirrors;
selecting an operating mode for each galvanometer motor; and,
displaying an animated model of the two-axis scanning system, the model comprising a moving image of the galvanometer motors and mirrors and a scan beam scanning over a two-axis scan field.

13. The method of claim 12 further comprising:
selecting a third galvanometer motor and a third scanning mirror for forming a three-axis scanning system;
selecting an operating mode for the third galvanometer motor; and,
displaying an animated model of the three-axis scanning system, the model comprising a moving image of the galvanometer motors and mirrors and a scan beam scanning over a three-axis scan field.

14. A method comprising:
selecting a plurality of optical components for a scanning system;
retrieving data relating to each of the selected optical components;
assembling the selected components into a scanning system model according to program steps operating on a controller;
operating the model to evaluate the performance of the components assembled into the scanning system; and,
displaying data derived by the model for evaluation by a user.

15. The method of claim 14 further comprising the step of displaying an animated representation of the operating of the scanning system.

16. The method according to claim 15 further comprising the step of displaying a beam being scanned by the scanning system.

17. The method of claim 14 further comprising the step of selecting an operating mode from a plurality of operating mode choices for at least one of the plurality of optical components.

18. The method of claim 14 wherein the step of selecting a plurality of optical components includes selecting two galvanometer scanning motors and two galvanometer scanning mirrors.

19. The method of claim 18 further comprising selecting a servo current driver for driving at least one of the galvanometer scanning motors.
